(19) United States
(12) Patent Application Publication
(10) Pub. No.: US 2024/0043738 A1
(43) Pub. Date: Feb. 8, 2024

(54) ADDITIVES AND METHODS, COMPOSITIONS AND USES RELATING THERETO

(71) Applicant: Independence Oilfield Chemicals LLC, The Woodlands, TX (US)

(72) Inventors: Jeffrey Scott Dupont, Conroe, TX (US); Richard A. Mitchell, Houston, TX (US); Jeffrey C. Dawson, Conroe, TX (US)

(21) Appl. No.: 18/226,942

(22) Filed: Jul. 27, 2023

Related U.S. Application Data
(60) Provisional application No. 63/392,947, filed on Jul. 28, 2022.

(51) Int. Cl. C09K 8/60; C09K 8/86; C09K 8/035; C09K 8/528; C09K 8/68; C09K 8/467; E21B 21/06

(52) U.S. Cl. CPC C09K 8/607; C09K 8/602; C09K 8/86; C09K 8/035; C09K 8/528; C09K 8/68; C09K 8/467; E21B 21/062; C09K 2208/12; E21B 21/065

(57) ABSTRACT

The use of a quaternary ammonium salt of a polyalkoxylated amine as a stabilisation additive in an oilfield fluid comprising water.

### TECHNICAL FIELD AND BACKGROUND

The present invention relates to additives for providing stability in oilfield applications, such as for stabilising clay in oilfield applications. In particular the invention relates to additives used in drilling fluids and fracturing fluids, which can stabilise clay.

Hydrocarbons (crude oil or natural gas) are recovered from boreholes (wells) drilled deep into the earth. Conventionally a borehole is drilled using a rotary drill bit on the end of a rotatable, hollow, drill pipe.

Drilling fluid is a complex mixture of liquids, solids and chemicals that must be formulated to provide the specific physical and chemical characteristics required to safely drill a well. Particular functions of the drilling fluid include cooling and lubricating a drill bit, lifting rock cuttings to the surface, preventing the destabilization of the rock at the wellbore walls and applying a hydrostatic pressure at the bit to overcome the pressure of fluids inside the rock so that these fluids do not enter the wellbore and progress to the surface uncontrollably.

Hydraulic fracturing is a process needed to produce oil and gas from unconventional reservoirs such as coal beds, tight sandstones and shales. In this process, a fracturing fluid is injected at a rate and pressure necessary to cause formation failure by inducing fractures or cracks in the formation. These cracks originate at the well-bore and radiate out into the formation.

Boreholes pass through many layers of rock, including formations containing clay. Thus drilling fluids and fracturing fluids are contacted with clay materials. The structure of certain clays encountered when drilling, for example smectites, means that they swell upon contact with water. Water is adsorbed between the layers of clay. This swelling can lead to dispersion of clay within a water-containing medium. The dispersed particles may fall apart and are then difficult to remove by simple techniques such as filtration. This can lead to undesirable consequences in oilfield applications.

Drilling fluids perform a number of functions, including lubrication of the drill bit and carrying of cuttings from the borehole to the surface. The cuttings are removed from the drilling fluid so it can be reused. The cuttings are typically removed from the drilling fluid by filtration. It is therefore desirable to prevent or reduce the disintegration of the cuttings as larger cuttings are more easily removed by filtration. It is important that the drilling fluid maintains a consistent rheology and has a low solids content. Re-use of drilling fluids is clearly environmentally and economically advantageous.

While both oil-based and water-based drilling fluids are available, it is preferable to use water-based fluids for economic and environmental reasons. However difficulties can arise with the use of water containing fluids when drilling through clay due to swelling and disintegration of clay cuttings, as well as potential issues around the stability of the wall of the borehole. Additionally the adherence of clays to the cutting face of drill bits is known to impair their cutting ability.

It is therefore highly desirable to provide an additive for water-containing drilling fluids which reduces the swelling and disintegration of clay containing cuttings.

There are other situations where swelling and disintegration of clay particulate matter can cause problems in water containing fluids. For example clay containing fines present in fracturing fluids comprising water may swell and become dispersed, which impairs fluid flow and makes the clay difficult to remove, preventing re-use of the fluids. Additionally, clays or clay containing fines can cause problems during oilfield cementing processes, in which oilfield cement is pumped into a borehole for example to seal it. For example the presence of clays or clay containing fines can destabilise the oilfield cement and provide a weakened cement product, as well as interfering with the performance of other additives present and/or leading to swelling within a borehole.

Various additives are known for preventing or reducing swelling and disintegration of clay particulates.

One additive commonly used in drilling fluids is potassium chloride. Potassium ions interact with anionic residues on the surface of the clay pulling the layers close together and inhibiting the penetration of water. However high treat rates of 3 to 7 wt % are needed which can affect the consistency of the drilling fluid and increase costs (including costs associated with disposal of fluids that contain high contents of potassium chloride).

The addition of amines is also known, with ammonium ions functioning in a similar way to potassium ions. However, one of the problems with these additives is that they are only compatible with acidic fluids.

The addition of partially hydrolysed polyacrylamide copolymers to encapsulate clay particles is also known from the prior art.

### SUMMARY

However there is a continuing need to provide further means by which particulates, such as clay particulates, for example cuttings from a borehole, can be stabilised in a drilling or fracturing fluid comprising water. It is desirable for such further means to comprise additives that can be used in a wider range of fluids and at lower treat-rates that the prior art additives.

### DETAILED DESCRIPTION

According to a first aspect of the present invention, there is provided the use of a quaternary ammonium salt of a polyalkoxylated amine as a stabilisation additive in an oilfield fluid comprising water.

According to a second aspect of the present invention, there is provided an oilfield fluid comprising water and a stabilisation additive wherein the stabilisation additive is a quaternary ammonium salt of a polyalkoxylated amine.

According to a third aspect of the present invention there is provided the use of a quaternary ammonium salt of a polyalkoxylated amine as a clay stabilisation additive in an oilfield fluid comprising water.

According to a fourth aspect of the present invention there is provided a method of stabilising clay in an oilfield fluid comprising water; the method comprising adding to oilfield fluid a quaternary ammonium salt of a polyalkoxylated amine.

According to fifth aspect of the present invention there is provided an oilfield fluid comprising water and a clay stabilisation additive wherein the clay stabilisation additive is a quaternary ammonium salt of a polyalkoxylated amine.

According to a sixth aspect of the present invention there is provided a method of improving the recovery of cuttings from drilling fluid, the method comprising adding to drilling fluid (such as a drilling fluid comprising water) a quaternary ammonium salt of a polyalkoxylated amine.

According to a seventh aspect of the present invention there is provided a drilling fluid additive composition comprising a quaternary ammonium salt of a polyoxyalkylated amine, a polysaccharide viscosifier (for example xanthan gum and/or diutan) and a fluid loss agent (for example carboxymethyl cellulose or carboxymethyl starch).

Preferred features of the first, second, third, fourth, fifth, sixth and seventh aspects of the invention will now be defined.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

The present invention relates to stabilisation additives for oilfield fluids. References herein to stabilisation may mean that the additive may improve wellbore stability and/or improve stability of drilling cuttings and/or reduce the disintegration of drilling cuttings and/or improve fines stability.

By oilfield fluids we mean to refer to drilling fluids, fracturing fluids, spacer fluids, acidising fluids, oilfield cements and wellbore cleaning fluids. For example, the oilfield fluid may be one or more of drilling fluids, fracturing fluids, spacer fluids, acidising fluids and wellbore cleaning fluids.

References herein to features of oilfield fluids are intended to relate to oilfield fluids in and to which the quaternary ammonium salt of a polyalkoxylated amine may be used and added.

Suitably, the oilfield fluids may be drilling fluids and fracturing fluids.

A typical oilfield fluid may be aqueous, hydrocarbon based or an emulsion (i.e. an oil-in-water or a water-in-oil emulsion). Preferably the oilfield fluid is aqueous. In other words, the oilfield fluid preferably comprises water. An aqueous oilfield fluid may comprise water that originates from freshwater, sea water, natural or synthetic brines, recycled drilling fluids or fracturing fluids, or mixtures of these. An aqueous oilfield fluid may comprise at least 5 vol % of water. An aqueous oilfield fluid may comprise up to 99 vol % of water.

In some embodiments the oilfield fluid is a drilling fluid.

The first aspect of the present invention may provide the use of a quaternary ammonium salt of a polyalkoxylated amine as a stabilisation additive in a drilling fluid comprising water.

The second aspect of the present invention may provide a drilling fluid comprising water and a stabilisation additive wherein the stabilisation additive is a quaternary ammonium salt of a polyalkoxylated amine.

The third aspect of the present invention may provide the use of a quaternary ammonium salt of a polyalkoxylated amine as a clay stabilisation additive in a drilling fluid comprising water.

The fourth aspect of the present invention may provide a method of stabilising clay in a drilling fluid comprising water; the method comprising adding to the drilling fluid a quaternary ammonium salt of a polyalkoxylated amine.

The fifth aspect of the present invention may provide a drilling fluid comprising water and a clay stabilisation additive wherein the clay stabilisation additive is a quaternary ammonium salt of a polyalkoxylated amine.

In some embodiments the oilfield fluid is a fracturing fluid.

When the oilfield fluid is a fracturing fluid, after the fracturing treatment and as the fracture closes onto the proppant pack, the quaternary ammonium salt of a polyalkoxylated amine may prevent fines migration due to spalling from proppant embedment in the fracture face.

The first aspect of the present invention may provide the use of a quaternary ammonium salt of a polyalkoxylated amine as a stabilisation additive in a fracturing fluid comprising water.

The second aspect of the present invention may provide a fracturing fluid comprising water and a stabilisation additive wherein the stabilisation additive is a quaternary ammonium salt of a polyalkoxylated amine.

The third aspect of the present invention may provide the use of a quaternary ammonium salt of a polyalkoxylated amine as a clay stabilisation additive in a fracturing fluid comprising water.

The fourth aspect of the present invention may provide a method of stabilising clay in a fracturing fluid comprising water; the method comprising adding to the fracturing fluid a quaternary ammonium salt of a polyalkoxylated amine.

The fifth aspect of the present invention may provide a fracturing fluid comprising water and a clay stabilisation additive wherein the clay stabilisation additive is a quaternary ammonium salt of a polyalkoxylated amine.

In some embodiments the oilfield fluid is a spacer fluid.

The first aspect of the present invention may provide the use of a quaternary ammonium salt of a polyalkoxylated amine as a stabilisation additive in a spacer fluid comprising water.

The second aspect of the present invention may provide a spacer fluid comprising water and a stabilisation additive wherein the stabilisation additive is a quaternary ammonium salt of a polyalkoxylated amine.

The third aspect of the present invention may provide the use of a quaternary ammonium salt of a polyalkoxylated amine as a clay stabilisation additive in a spacer fluid comprising water.

The fourth aspect of the present invention may provide a method of stabilising clay in a spacer fluid comprising water; the method comprising adding to the spacer fluid a quaternary ammonium salt of a polyalkoxylated amine.

The fifth aspect of the present invention may provide a spacer fluid comprising water and a clay stabilisation additive wherein the clay stabilisation additive is a quaternary ammonium salt of a polyalkoxylated amine.

In some embodiments the oilfield fluid is an oilfield cement.

By oilfield cement we mean a cement slurry prepared by combining a cement composition with water. Thus, references herein to an oilfield cement are intended to mean such a cement comprising water.

The first aspect of the present invention may provide the use of a quaternary ammonium salt of a polyalkoxylated amine as a stabilisation additive in an oilfield cement.

The second aspect of the present invention may provide an oilfield cement and a stabilisation additive wherein the stabilisation additive is a quaternary ammonium salt of a polyalkoxylated amine.

The third aspect of the present invention may provide the use of a quaternary ammonium salt of a polyalkoxylated amine as a clay stabilisation additive in an oilfield cement.

The fourth aspect of the present invention may provide a method of stabilising clay in an oilfield cement; the method comprising adding to the oilfield cement a quaternary ammonium salt of a polyalkoxylated amine.

The fifth aspect of the present invention may provide an oilfield cement comprising a clay stabilisation additive wherein the clay stabilisation additive is a quaternary ammonium salt of a polyalkoxylated amine.

The present invention relates to the use of a stabilisation additive, for example a clay stabilisation additive, which is a quaternary ammonium salt of a polyalkoxylated amine. The stabilisation additive may be a clay stabilisation additive.

The quaternary ammonium salt suitably comprises a quaternary ammonium cation and an anion.

The cation and anion may be separate species.

In some embodiments the cation and anion may be covalently bonded as part of the same molecule to form a zwitterion.

The quaternary ammonium salt is preferably prepared by reacting a polyalkoxylated amine with a quaternising agent. In some embodiments the quaternary ammonium salt used as the stabilisation additive, for example clay stabilisation additive, may be the direct reaction product of the polyalkoxylated amine and the quaternising agent. In some embodiments the quaternary ammonium salt used as the stabilisation additive, for example clay stabilisation additive, may be prepared by reacting the polyalkoxylated amine with a quaternising agent, followed by a subsequent ion exchange or substitution reaction to provide a salt as the additive having a different anion.

The invention relates to a polyalkoxylated amine. By this we mean to refer to a compound which includes at least one amino group which has been alkoxylated. The compound includes multiple alkoxy residues.

When the amine includes more than one amino group, one or more than one of the amino groups may be alkoxylated.

The polyalkoxylated amine may be a monoamine, a diamine, a triamine, a tetramine or a polyamine. The polyalkoxylated amine may be an alkanolamine.

The skilled person will appreciate that when a diamine or polyamine is polyalkoxylated, the alkoxy groups may be distributed according to relative reactivity or steric hindrance of the amino groups.

Polyalkoxylated amines typically comprise mixtures of compounds having different degrees of alkoxylation. It is therefore useful to define these compounds in terms of the average degree of alkoxylation.

The polyalkoxylated amine preferably includes at least 5 alkoxy moieties per amino group.

By alkoxy moiety we mean to refer to the moiety —(RO)— in which R is an alkylene group. Thus RO is suitably an alkylene oxide residue, preferably an ethylene oxide, propylene oxide or butylene oxide residue. Mixtures of different alkylene oxide residues may be present.

R is preferably an ethylene, propylene or butylene group. R may be an n-propylene or n-butylene group or an isopropylene or isobutylene group. For example R may be —CH₂CH₂—, —CH₂CH(CH₃)—, —CH₂C(CH₃)₂—, —CH(CH₃)CH(CH₃)— or —CH₂CH(CH₂CH₃)—.

R may comprise a mixture of isomers. For example when R is propylene, the polyalkoxylated amine may include moieties —CH₂CH(CH₃)— and —CH(CH₃)CH₂— in any order within the polyoxyalkylene chain.

Each R may be the same or different. R may comprise a mixture of different groups for example ethylene, propylene or butylene units. Block copolymer units are preferred in such embodiments.

Preferably R is ethylene and/or propylene. More preferably R is —CH₂CH₂— or —CH(CH₃)CH₂—.

Preferably the polyalkoxylated amine includes at least 5 alkoxy moieties per amino group, preferably at least 8 alkoxy moieties per amino group, more preferably at least 10 alkoxy moieties per amino group.

The polyalkoxyamine may comprise up to 100 alkoxy moieties per amino group, for example up to 80 or up to 60 or up to 50.

Preferably the polyalkoxyamine comprises from 10 to 80, preferably from 16 to 72, more preferably from 20 to 40, for example from 30 to 50 alkoxy moieties per amino group.

The amine which is polyalkoxylated may comprise one or more than one amino group.

Preferably the amine comprises two or more amino groups.

In some embodiments the amine may be a polyethyleneimine, i.e. a compound of formula —[CH₂CH₂NH]ₙ—. Preferred polyethyleneimines are compounds having a number average molecular weight of from 400 to 5000, preferably from 600 to 4000, more preferably from 1000 to 3000, for example from 1500 to 2000.

Examples of suitable amines may be as disclosed in U.S. Pat. Nos. 4,661,288 and/or 6,452,035.

For example, suitable amines include 1-aminopiperidine, 1-(2-aminoethyl)piperidine, 1-(3-aminopropyl)-2-pipecoline, 1-methyl-(4-methylamino)piperidine, 4-(1-pyrrolidinyl)piperidine, 1-(2-aminoethyl)pyrrolidine, 2-(2-aminoethyl)-1-methylpyrrolidine, N,N-diethylethylenediamine, N,N-dimethylethylenediamine, N,N-dibutylethylenediamine, N,N-diethyl-1,3-diaminopropane, N,N-dimethyl-1,3-diaminopropane, N,N,N′-trimethylethylenediamine, N,N-dimethyl-N′-ethylethylenediamine, N,N-diethyl-N′-methylethylenediamine, N,N,N′-triethylethylenediamine, 3-dimethylaminopropylamine, 3-diethylaminopropylamine, 3-dibutylaminopropylamine, N,N,N′-trimethyl-1,3-propanediamine, N,N,2,2-tetramethyl-1,3-propanediamine, 2-amino-5-diethylaminopentane, N,N,N′,N′-tetraethyldiethylenetriamine, 3,3′-diamino-N-methyldipropylamine, 3,3′-iminobis(N,N-dimethylpropylamine), 1-(3-aminopropyl)imidazole, 4-(3-aminopropyl)morpholine, 1-(2-aminoethyl)piperidine, 3,3-diamino-N-methyldipropylamine, 3,3-aminobis(N,N-dimethylpropylamine), 3-(2-(dimethylamino)ethoxy)propylamine, ethylenediamine, diethylenetriamine, triethylenetetramine, tetraethylenepentamine, pentaethylene-hexamine, hexaethyleneheptamine, heptaethyleneoctamine, propane-1,2-diamine, 2(2-amino-ethylamino)ethanol, para benzene diamine, naphthalene diamine, 1,4-diaminocylcohexane and N′,N′-bis (2-aminoethyl) ethylenediamine (N(CH₂CH₂NH₂)₃).

In some embodiments the amine may be a polyamine. Suitable polyamines include N,N-diethylethylenediamine, N,N-dimethylethylenediamine, N,N-dibutylethylenediamine, N,N-diethyl-1,3-diaminopropane, N,N-dimethyl-1,3-diaminopropane, N,N,N′-trimethylethylenediamine, N,N-dimethyl-N′-ethylethylenediamine, N,N-diethyl-N′-methylethylenediamine, N,N,N′-triethylethylenediamine, 3-dimethylaminopropylamine, 3-diethylaminopropylamine, 3-dibutylaminopropylamine, N,N,N′-trimethyl-1,3-propanediamine, N,N,2,2-tetramethyl-1,3-propanediamine, 2-amino-5-diethylaminopentane, N,N,N′,N′-tetraethyldiethylenetriamine, 3,3′-diamino-N-methyldipropylamine, 3,3′-iminobis(N,N-dimethylpropylamine), 1-(3-aminopropyl)imidazole, 4-(3-aminopropyl)morpholine, 1-(2-aminoethyl)piperidine, 3,3-diamino-N-methyldipropylamine, 3,3-aminobis(N,N-dimethylpropylamine), 3-(2-(dimethylamino)ethoxy)propylamine, ethylenediamine, diethylenetriamine, triethylenetetramine, tetraethylenepentamine, pentaethylenehexamine, hexaethyleneheptamine, heptaethyleneoctamine, propane-1,2-diamine, 2(2-amino-ethylamino)ethanol, para benzene diamine, naphthalene diamine, 1,4-diaminocylcohexane and N′,N′-bis (2-aminoethyl) ethylenediamine (N(CH₂CH₂NH₂)₃).

In some embodiments, the amine may be ethylenediamine, diethylenetriamine, triethylenetetramine, tetraethylenepentamine, pentaethylene-hexamine, hexaethyleneheptamine, heptaethyleneoctamine, propane-1,2-diamine, 2(2-amino-ethylamino)ethanol, para benzene diamine, naphthalene diamine, 1,4-diaminocylcohexane or N′,N′-bis (2-aminoethyl) ethylenediamine (N(CH₂CH₂NH₂)₃

In some preferred embodiments the polyalkoxylated amine comprises from 1 to 10, preferably 1 to 6 amino groups and from 20 to 200, preferably 50 to 150 alkoxy moieties.

In some embodiments the polyalkoxylated amine has the formula (I):

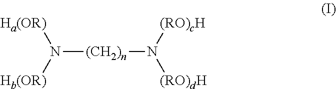

wherein each R is independently an alkylene group; n is from 1 to 30, and a+b+c+d is at least 8.

For the avoidance of doubt, a, b, c and d each relate to the number of (RO) repeat units (such that a+b+c+d gives the total number of alkoxy moieties present).

Preferably n is from 1 to 20, preferably from 2 to 12, more preferably from 3 to 10, preferably from 4 to 8.

Preferably a+b+c+d is at least 10, preferably at least 12, preferably at least 20, more preferably at least 30, suitably at least 40, for example at least 50 or at least 60.

Suitably a+b+c+d is from 40 to 120, preferably from 60 to 100, for example from 70 to 90.

Preferably a is at least 2, b is at least 2, c is at least 2 and d is at least 2.

Preferably a is from 10 to 30, preferably 15 to 25; b is from 10 to 30, preferably 15 to 25; c is from 10 to 30, preferably 15 to 25; and d is from 10 to 30, preferably from 15 to 25.

In an especially preferred embodiment n is 6; each R is CH₂CH₂ and each of a, b, c and d is on average 20.

The skilled person will appreciate that compounds of this type are typically mixtures and the above amounts refer to the average number of alkoxy groups per molecule.

The stabilisation additive, for example clay stabilisation additive, is a quaternary ammonium salt of a polyalkoxylated amine. Preferably the quaternary ammonium salt is prepared by reacting the polyalkoxylated amine with a quaternising agent. Optionally the direct product of the quaternising reaction may be further reacted to provide the additive.

In embodiments in which the polyalkoxylated amine comprises primary and/or secondary amino groups multiple molar equivalents of quaternising agent may be needed.

Most preferably the polyalkoxylated amine comprises predominantly only tertiary amino groups. Typically the compounds will have been prepared from non-tertiary amines which have been alkoxylated to provide predominantly tertiary amino groups.

Any suitable quaternising agent may be used.

The quaternary ammonium salts of the present invention may be prepared by reaction of a tertiary amine with a quaternising agent selected from dialkyl sulfates, benzyl halides, hydrocarbyl substituted carbonates, alkyl halides, alkyl sulfonates, sultones, hydrocarbyl substituted phosphates, hydrocarbyl substituted borates, alkyl nitrites, alkyl nitrates, hydroxides, N-oxides, esters of a carboxylic acid, chloroacetic acid and salts thereof, hydrocarbyl substituted epoxides optionally in combination with an acid, or mixtures thereof; optionally followed by an anion exchange or a substitution reaction.

An especially preferred quaternising agent for use herein is dimethyl sulfate.

In some embodiments the stabilisation additive, for example clay stabilisation additive, includes a quaternary ammonium cation and a separate anion.

In some preferred embodiments the anion and cation are part of the same covalently bonded molecule and form a zwitterionic species.

In some preferred embodiments the quaternising agent is dimethyl sulfate and the direct reaction product of the amine and the quaternising agent is further reacted with a strong acid to effect substitution of one or more hydroxy residues of the cation with a sulfate group. This results in a zwitterionic species including a nitrogen cation and a sulfate anion.

In some preferred embodiments the amine may be reacted with any suitable quaternising agent (for example as disclosed herein) and reacted with a conventional sulfation agent such as sulfur trioxide.

In some preferred embodiments the stabilisation additive, for example clay stabilisation additive, comprises compounds of formula (II):

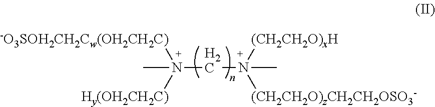

wherein w+x+y+z is from 60 to 100 and n is from 4 to 8.

For the avoidance of doubt, w, x, y and z each relate to the number of (CH₂CH₂O) repeat units (such that w+x+y+z gives the total number of ethoxy moieties present).

One especially preferred compound for use herein is a compound of Formula (III):

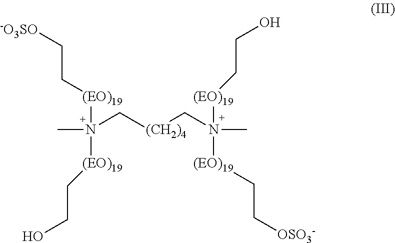

wherein EO represents an ethylene oxide moiety.

The skilled person will appreciate that the structure of the compound of formula (III) represents an average molecule in which on average 20 ethoxy groups are in a chain but of course the compound itself will comprise a mixture of homologues and isomers.

The stabilisation additive, for example clay stabilisation additive, is preferably included in the oilfield fluid in an amount effective to improve the stability of particulate matter, for example clay particulate matter, within the fluid and reduce disintegration thereof; and/or to improve the stability of material, for example clay material, in the borehole wall.

The necessary effective amount of the stabilisation additive, for example clay stabilisation additive, will depend on the nature of the oilfield fluid, such as the amount of clay present in the oilfield fluid and other factors such as the temperature of the oilfield fluid. The selection of an appropriate treat rate will be within the competence of the skilled person.

Typically the stabilisation additive, for example clay stabilisation additive, is included in the oilfield fluid in an amount of from 0.01 to 30 vol %, preferably 0.1 to 20 vol %, more preferably 0.1 to 10 vol % or 0.5 to 10 vol %, preferably 0.75 to 5 vol %.

Preferably the inclusion of the stabilisation additive, for example clay stabilisation additive, results in at least 50 wt % of the particular matter, for example clay particulate matter, being recoverable from the fluid, preferably at least 60 wt %, more preferably at least 70 wt %, suitably at least 80 wt %, for example at least 90 wt %.

By recoverable from the fluid we mean that the particulate matter, for example clay particulate matter, remains in a form which can be easily removed from the fluid. Suitably, the particulate matter, for example clay particulate matter, substantially remains in its original size, which size is sufficient to remove a majority of the matter (for example cuttings) from the fluid by filtration.

The stabilisation additive, for example clay stabilisation additive, can be used in any oilfield fluid comprising particulate matter, for example clay particulate matter, and/or in contact with matter, for example clay containing matter, where prevention of disintegration of the matter, for example clay containing matter, is desirable.

In some embodiments the oilfield fluid is a fracturing fluid.

Fracturing fluids are used to extend fractures, add lubrication, and to carry proppant into the formation. Fracturing fluids typically comprise a slurry of water, proppant, and chemical additives. Water-soluble gelling agents are added to increase viscosity.

Preferably the fracturing fluid comprises from 70 to 95 wt %, preferably 85 to 95 wt % water; from 1 to 20 wt %, preferably 5 to 15 wt % proppant and from 0.1 to 5 wt %, preferably 0.2 to 1 wt % additives.

The proppant is a granular material that prevents the created fractures from closing after the fracturing treatment. Suitable proppants include silica sand, resin-coated sand, bauxite, and man-made ceramics. Silica sand is preferred.

The composition of the fracturing fluid depends on the type of fracturing desired, the conditions of specific wells being fractured, and water characteristics. Important properties of the fracturing fluid include viscosity, pH and various rheological factors.

The fracturing fluid may comprise one or more further additives. These are preferably selected from: acids, especially hydrochloric acid or acetic acid; sodium chloride; friction reducers, especially polyacrylamides; ethylene glycol; borate salts; sodium and/or potassium carbonate; a biocide, for example glutaraldehyde; water-soluble gelling agents, especially guar gum; corrosion inhibitors, especially citric acid; scale inhibitors; clay control agents; flow-back additives; iron control agents; and winterising agents, especially isopropanol.

Further suitable additives may be selected from borate cross-linkers, high pH buffers and gel degrading substances such as polymer-specific enzymes and oxidiziers.

A person skilled in the art would be able to select suitable additives and treat rates thereof for a fracturing fluid according to the intended application thereof.

In some preferred embodiments oilfield fluid is a drilling fluid.

Preferred drilling fluids are water-based muds. Typically, components of such water based muds will be known to the person skilled in the art. Water-based muds may contain from 5 to 99 vol %, such as from 25 to 95 vol % or from 30 to 90 vol %, of water.

The drilling fluid may comprise one or more further additives. These are preferably selected from: hardness control/water softening agents; pH control agents; fluid loss agents, especially carboxymethyl starch or carboxymethyl cellulose; viscosifiers; salts and other weighting agents; scale inhibitors; lost circulation material or bridging agents; defoaming agents; biocides; corrosion inhibitors; oxygen scavengers; hydrogen sulfate scavengers; scale inhibitors; pipe-release agents; emulfisifers; dispersants; dewatering agents; filter cake removal agents; and lubricants.

A person skilled in the art would be able to select suitable additives and treat rates thereof for a drilling fluid according to the intended application thereof.

Examples of suitable viscosifiers include clays for example attapulgite; and polysaccharides and derivatives thereof for example cellulose, carboxymethyl cellulose, hydroxyethyl cellulose, polyanionic cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin and cyclodextrin. Preferred are xanthan and/or diutan.

Examples of suitable salts and other weighting agents include KCl, NaCl, MgCl₂, barite (barium sulfate), calcium carbonate, iron oxide and galena.

Examples of suitable lost circulation materials/bridging agents include crushed nut shells, shredded cellophane, carbonate particles, diatomaceous earth, marble, starch, lignins and tanins, ground tire, paper, polyethylene chips and polylactic acid. These may be in the form of fine powder, coarse powder, fibres or flakes.

Examples of suitable fluid loss agents include polyanionic cellulose, sodium polyacrylates, carboxymethyl starch and carboxymethyl cellulose.

Examples of suitable defoaming agents include aluminium stearate, alkyl phosphate, polyols and silicones.

Examples of suitable biocides include glutaraldehyde, quaternary ammonium chloride salts including alkyldimethylbenzylammonium chlorides and alkyltrimethylammonium chlorides, peracetic acid, methylisothiazolinone, bronopol and tetrakis (hydroxymethyl) phosphonium sulfate (THPS).

Examples of suitable corrosion inhibitors include imidazolines, alkoxylated alcohols and triazoles.

Examples of suitable oxygen scavengers include aluminium bisulfate.

Examples of suitable hydrogen sulfate scavengers include iron oxide, zinc carbonates, zinc oxide, triazine and acrolein.

Examples of suitable scale inhibitors include phosphate esters and phosphonates.

Examples of suitable lubricants include sulfonate asphalts, fatty acids, triglycerides, alkoxylated fatty acids, alkoxylated vegetable oils, hydrocarbon oils, isoparaffins, fatty alcohols, and alkylglucoside.

Examples of suitable emulsifiers and dispersants include fatty acids and sulfonates.

Examples of suitable dewatering agents include polyamines, polyacrylamides and DADMAC copolymers.

Examples of suitable filter cake removal agents include α-amylase enzymes.

Examples of suitable hardness control agent includes soda ash (carbonate).

In some embodiments the oilfield fluid is an oilfield cement.

The oilfield cement may be any suitable oilfield cement, such as an American Petroleum Institute (API) class A-H cement. For example, the oilfield cement may comprise Portland cement. The oilfield cement may be suitable for use in remedial and/or primary cement applications.

The oilfield cement may be a weighted oilfield cement, for example having a density of above about 11 ppg (pounds per US gallon), such as from about 11.5 to 19.0 ppg.

A suitable weighted oilfield cement may comprise a suitable weighting agent. Examples of suitable weighting agents include barite, hematite, ilmenite and manganese tetraoxide.

The oilfield cement may comprise one or more further additives. These are preferably selected from: accelerators; anti-foams; retarders; extenders; fluid loss agents; dispersants; lost circulation materials; retarders; weighting agents; bond improvers; expanders; foamers; foam stabilizers; free water control agents; gas migration agents; mud removal agents; slag activators; sodium chloride; strength retrogression preventers; and thixotropic additives.

A person skilled in the art would be able to select suitable additives and treat rates thereof for an oilfield cement according to the intended application thereof.

Examples of suitable accelerators include calcium chloride.

Examples of suitable anti-foams include polyethylene glycol.

Examples of suitable extenders include bentonite, sodium silicates and pozzolan clays.

Examples of suitable fluid loss agents include hydroxyethyl cellulose, polyamines, sulfonated aromatic polymers, polyvinylpyrrolidone, polyvinylalcohol, 2-acrylamido-2-methylpropane sulfonic acid (AMPS) copolymers and terpolymers.

Examples of suitable dispersants include polynapthalene sulphonate, polymelamine sulfonate, lignosulfonates, polystyrene sulfonates and hydroxylated polysaccharides.

Examples of suitable lost circulation materials include ground coal, ground gilsonite, and ground walnut hull, fibres or flaked materials (for example cellophane).

Examples of suitable retarders include lignosulfonates (Ca/Na) salts, carboxymethyl hydroxyethyl cellulose (CMHEC), hydroxycarboxylic acids (for example citric acid) and organophosphonates.

In some embodiments the oilfield fluid may comprise a further stabilisation additive, for example a clay stabilisation additive. Preferred further stabilisation additives, for example clay stabilisation additives, include potassium chloride, magnesium chloride and polyethyleneimines.

Magnesium chloride is preferably included in an amount of from 1 to 99 wt %, preferably 10 to wt %, for example 40 to 50 wt % based on the weight of the quaternary ammonium salt of the polyoxyalkylated amine.

The polyethyleneimine is preferably included in an amount of up to 10 wt %, for example 0.1 to wt % or 1 to 3 wt % based on the weight of the quaternary ammonium salt of the polyoxyalkylated amine.

Potassium chloride is preferably included in an amount of from 1 to 50 wt %, preferably 1 to 25 wt %, for example 2 to 10 wt % based on the weight of the quaternary ammonium salt of the polyoxyalkylated amine.

The quaternary ammonium salt of a polyalkoxylated amine (for example as described herein) may improve the performance of a further additive, such as the performance of a further performance additive (such as a superplasticiser) or stabilisation additive.

The seventh aspect of the present invention may provide a drilling fluid additive composition comprising a quaternary ammonium salt of a polyoxyalkylated amine, a polysaccharide viscosifier (for example xanthan gum and/or diutan) and a fluid loss agent (for example carboxymethyl cellulose or carboxymethyl starch).

Typically the quaternary ammonium salt of a polyalkoxylated amine is included in the drilling fluid additive composition in an amount of from 0.01 to 30 vol %, preferably 0.1 to 20 vol %, more preferably 0.1 to 10 vol % or 0.5 to 10 vol %, preferably 0.75 to 5 vol %.

Typically the quaternary ammonium salt of a polyalkoxylated amine is included in the drilling fluid additive composition in an amount of from 0.01 to 30 wt %, preferably 0.1 to 20 wt %, more preferably 0.1 to 10 wt % or 0.5 to 10 wt %, preferably 0.75 to 5 wt %.

### WORKING EXAMPLES

The invention will now be further described by reference to the following non-limiting examples.

### Example 1

The performance of stabilisation additives was assessed using a Maxwell water based mud (WBM) and bentonite clay pellets. The clay pellets were ground to a size of 2 to 4 mm and then added in an amount of 30 g in 350 mL WBM. The WBM has a pH 7-10.5.

Additives A, B and C were added to samples of the mud in an amount of 2.5 vol %.

Additive A is a commercially available additive sold under the trade mark ClayBrake 1500.

Additive B is a commercially available polysaccharide additive sold under the trade mark ClayBrake 1000.

Additive C is an additive of the invention having on average the structure below:

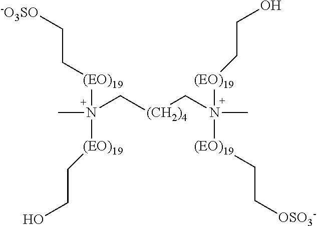

The water based mud (WBM) comprising the additive and 30 g of bentonite cuttings was placed in a 500 ml pressurized, aging cell and hot rolled for 16 hours at 82° C. then cooled down. The mud was poured over a No. 10 (2 mm) sieve screen stacked on top of No. 18 (1 mm) sieve screen and rinsed with 10% KCl in deionised water to remove all the mud from the cuttings before oven drying. The remaining cuttings were weighed to measure the material retained after hot rolling.

The results are shown in Table 1:

TABLE 1

| | A | B | |
|---|---|---|---|
| Additive | (comparative) | (comparative) | C |
| Initial mass of clay (g) | 30 | 30 | 30 |
| Final mass of clay (g) | 28.5 | 22.7 | 29.5 |
| % retained | 95% | 75.6% | 98.3% |

### Example 2

Example 1 was repeated except Additives D and E were added to samples of the mud in an amount of 3 vol %.

Additive D is 70 wt % of additive C and 30 wt % of magnesium chloride.

Additive E is 65 wt % of additive C, 30 wt % of magnesium chloride and 5 wt % of the polyamine Epomin 200 (a commercially available polyethyleneimine).

The results are shown in Table 2:

TABLE 2

| Additive | D | E |
|---|---|---|
| Wt. Bentonite Pellet Before Test (g) | 30.0 | 30.0 |
| Wt. Bentonite Pellet Recovered After Test (g) | 29.4 | 28.5 |
| Bentonite Pellet Loss After Test (g) | 0.6 | 1.5 |
| Bentonite Pellet Recovered (%) | 98% | 95% |

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of stabilizing an oilfield fluid comprising water, the method comprising adding to the oilfield fluid comprising water a quaternary ammonium salt of a polyalkoxylated amine.

2. An oilfield fluid comprising water and a stabilisation additive wherein the stabilisation additive is a quaternary ammonium salt of a polyalkoxylated amine.

3. (canceled)

4. A method of stabilising clay in an oilfield fluid comprising water; the method comprising adding to oilfield fluid a quaternary ammonium salt of a polyalkoxylated amine.

5. An oilfield fluid comprising water and a clay stabilisation additive wherein the clay stabilisation additive is a quaternary ammonium salt of a polyalkoxylated amine.

6. A method of improving the recovery of cuttings from drilling fluid, the method comprising adding to drilling fluid a quaternary ammonium salt of a polyalkoxylated amine.

7. The oilfield fluid according to claim 2, wherein the oilfield fluid is a fracturing fluid.

8. The oilfield fluid according to claim 2, wherein the oilfield fluid is a drilling fluid.

9. The oilfield fluid according to claim 2, wherein the oilfield fluid is an oilfield cement.

10. The oilfield fluid according to claim 2, wherein the polyalkoxylated amine is a polyalkoxylated polyethyleneimine.

11. The oilfield fluid according to claim 2, wherein the polyalkoxylated amine is polyalkoxylated polyamine.

12. The oilfield fluid according to claim 2, wherein the polyalkoxylated amine has the formula (I): 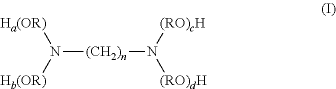
wherein each R is independently an alkylene group; n is from 1 to 30, and a+b+c+d is at least 10.

13. The oilfield fluid according to claim 2, wherein the polyalkoxylated amine has the formula (II): 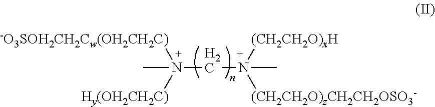
wherein w+x+y+z is from 60 to 100 and n is from 4 to 8.

14. The oilfield fluid according to claim 2, wherein the cation and anion of the quaternary ammonium salt of a polyalkoxylated amine are covalently bonded as part of the same molecule to form a zwitterion.

15. The oilfield fluid according to claim 2, wherein the quaternary ammonium salt of a polyalkoxylated amine has on average the formula (III): 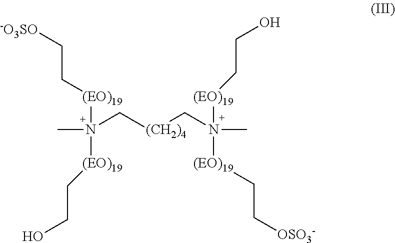
wherein EO represents an ethylene oxide moiety.

16. The oilfield fluid according to claim 2, wherein the quaternary ammonium salt of a polyalkoxylated amine is present in the oilfield or drilling fluid comprising water in an amount of from 0.1 to vol %.

17. The method according to claim 4, wherein the oilfield fluid is one of a fracturing fluid, a drilling fluid, an oilfield cement, or any combination thereof.

18. The method according to claim 4, wherein the polyalkoxylated amine is a polyalkoxylated polyethyleneimine.

19. The method according to claim 4, wherein the polyalkoxylated amine is polyalkoxylated polyamine.

20. The method according to claim 4, wherein the polyalkoxylated amine has the formula (I): 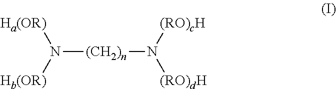
wherein each R is independently an alkylene group; n is from 1 to 30, and a+b+c+d is at least 10.

21. The method according to claim 4, wherein the polyalkoxylated amine has the formula (II): 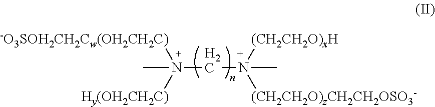
wherein w+x+y+z is from 60 to 100 and n is from 4 to 8; and/or wherein the cation and anion of the quaternary ammonium salt of a polyalkoxylated amine are covalently bonded as part of the same molecule to form a zwitterion; and/or wherein the quaternary ammonium salt of a polyalkoxylated amine has on average the formula (III): 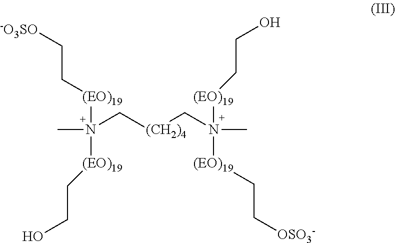
wherein EO represents an ethylene oxide moiety; and/or
wherein the quaternary ammonium salt of a polyalkoxylated amine is present in the oilfield or drilling fluid comprising water in an amount of from 0.1 to 10 vol %.
